(19) United States
(12) Patent Application Publication
(10) Pub. No.: US 2016/0304126 A1
(43) Pub. Date: Oct. 20, 2016

(54) VEHICLE CONTROL DEVICE

(71) Applicant: TOYOTA JIDOSHA KABUSHIKI KAISHA, Toyota-shi (JP)

(72) Inventors: Masaaki YAMAOKA, Susono-shi (JP); Yosuke WADA, Toyota-shi (JP)

(73) Assignee: TOYOTA JIDOSHA KABUSHIKI KAISHA, Toyota-shi (JP)

(21) Appl. No.: 15/092,710

(22) Filed: Apr. 7, 2016

(30) Foreign Application Priority Data
Apr. 14, 2015 (JP) 2015-082440

(51) Int. Cl. B62D 15/02; B60K 35/00

(52) U.S. Cl. CPC B62D 15/0255; B60K 35/00; B60K 2350/2008; B60K 2350/106

(57) ABSTRACT

By a display unit of a vehicle control device, a lane line which partitions a driving lane and a neighboring lane is displayed on a display screen in a perspective from a host vehicle to the front of the host vehicle and the lane line is displayed while the position of the lane line is changed according to a progress situation of a lane change. For this reason, a movement of the lane line in a display of the display screen and a movement of the lane line at the point of view of a driver of the host vehicle become more similar. Therefore, the driver of the host vehicle has a reduced uncomfortable feeling with the display of the display screen, and thus it becomes easier for the driver of the host vehicle to grasp the progress situation of the lane change.

### TECHNICAL FIELD

An aspect of the present invention relates to a vehicle control device.

### BACKGROUND

In the related art, as described in U.S. Pat. No. 8,346,426, a device which executes automatic driving of a host vehicle is known. A device of U.S. Pat. No. 8,346,426 controls the driving of a host vehicle such that the host vehicle performs a lane change from a driving lane on which the host vehicle travels to a neighboring lane which is contiguous to the driving lane.

The device of U.S. Pat. No. 8,346,426 displays a host vehicle box (icon) indicating the host vehicle and a lane in the vicinity of the host vehicle on a display screen in a perspective from above a road on which the host vehicle is traveling. At the time of the lane change, the device of U.S. Pat. No. 8,346,426 displays a progress situation of the lane change to a driver of the host vehicle through the display screen, by the host vehicle box.

### SUMMARY

Incidentally, in the related art described above, the host vehicle box indicating the host vehicle in the display screen moves according to the progress situation of the lane change, in a perspective from above the road on which the host vehicle is traveling. On the other hand, at the point of view from a vehicle interior of the driver of the host vehicle, a lane line outside of the host vehicle moves according to the progress situation of the lane change. For this reason, the driver feels uncomfortable with the display of the display screen, and thus it sometimes is difficult to grasp the progress situation of the lane change. Therefore improvement is desired.

Therefore, an object of the present invention is to provide a vehicle control device in which when controlling driving of a host vehicle so as to perform a lane change, it becomes easier for a driver of the host vehicle to grasp a progress situation of the lane change.

According to an aspect of the present invention, there is provided a vehicle control device which controls driving of a host vehicle such that the host vehicle performs a lane change from a driving lane on which the host vehicle travels to a neighboring lane which is contiguous to the driving lane, and displays a progress situation of the lane change to a driver of the host vehicle through a display screen, including: a display unit configured to display a lane line which partitions the driving lane and the neighboring lane, on the display screen in a perspective from the host vehicle to the front of the host vehicle, wherein the display unit is configured to display the lane line while changing a position of the lane line according to the progress situation of the lane change.

According to this configuration, by the display unit of the vehicle control device, the lane line which partitions the driving lane and the neighboring lane is displayed on the display screen in a perspective from the host vehicle to the front of the host vehicle and the lane line is displayed while the position of the lane line is changed according to the progress situation of the lane change. For this reason, a movement of the lane line in a display of the display screen and a movement of the lane line at the point of view of the driver of the host vehicle become more similar. Therefore, the driver of the host vehicle has a reduced uncomfortable feeling with the display of the display screen, and thus it becomes easier for the driver of the host vehicle to grasp the progress situation of the lane change.

In this case, the display unit may be configured to display a first target line indicating a direction of the lane change, in the display screen, and display the first target line while changing a shape of the first target line according to the progress situation of the lane change.

According to this configuration, by the display unit, the first target line indicating the direction of the lane change is displayed in the display screen on which similar display to that at the point of view of the driver is performed, and the shape of the first target line is changed according to the progress situation of the lane change. Therefore, it becomes easier for the driver of the host vehicle to grasp the direction of the lane change or the progress situation of the lane change.

Further, the display unit may be configured to perform display without having a color, before the host vehicle starts a movement to the neighboring lane, and perform display having a color, after the host vehicle starts a movement to the neighboring lane.

According to this configuration, by the display unit, display without having a color is performed before the host vehicle starts the movement to the neighboring lane, and display having a color is performed after the host vehicle starts the movement to the neighboring lane. Therefore, it becomes easier for the driver of the host vehicle to gasp whether or not the movement to the neighboring lane has started.

Further, in a case where after the host vehicle starts a movement to the neighboring lane, the driving of the host vehicle is controlled such that the host vehicle returns back to the driving lane, the display unit may be configured to display a second target line indicating a return to the driving lane, in the display screen.

According to this configuration, in a case where after the host vehicle starts the movement to the neighboring lane, the driving of the host vehicle is controlled such that the host vehicle returns back to the driving lane, the second target line indicating a return to the driving lane is displayed in the display screen by the display unit. Therefore, it becomes easier for the driver of the host vehicle to gasp the driving of the host vehicle being controlled such that the host vehicle returns back to the driving lane.

According to an aspect of the present invention, when controlling the driving of the host vehicle such that a lane change is performed, it becomes easier for the driver of the host vehicle to grasp a progress situation of the lane change.

### BRIEF DESCRIPTION OF THE DRAWINGS

FIG. 1 is a block diagram showing the configuration of a vehicle control device according to an embodiment.

FIG. 2 is a flowchart showing an operation of the vehicle control device of FIG. 1.

FIG. 3 is a plan view showing an operation of a host vehicle at each position in a case where the driving of the host vehicle is controlled such that the host vehicle performs a lane change.

FIGS. 4A, 4B, 4C, 4D, 4E, 4F, and 4G respectively are drawings showing the display of a display screen at each position in FIG. 3.

FIG. 5 is a plan view showing an operation of the host vehicle at each position in a case where the driving of the host vehicle is controlled such that the host vehicle returns back to a driving lane after the host vehicle starts a movement to a neighboring lane.

FIGS. 6X, 6Y, and 6Z respectively are drawings showing the display of the display screen at each position in FIG. 5.

### DETAILED DESCRIPTION

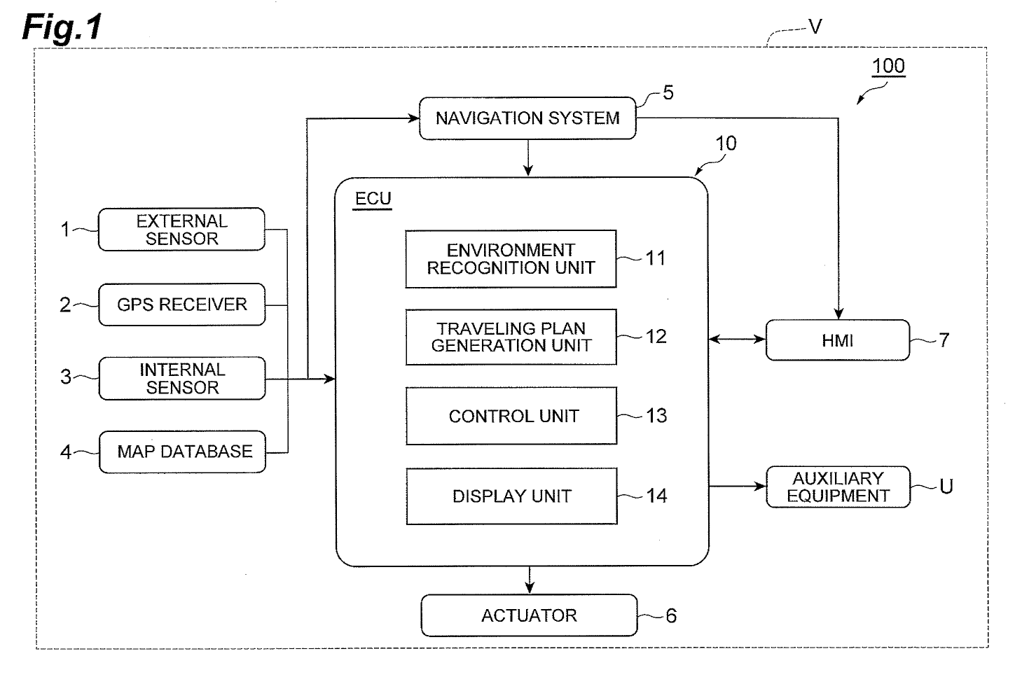

Hereinafter, an embodiment of the present invention will be described in detail using the drawings. As shown in FIG. 1, a vehicle control device 100 is mounted on a host vehicle V such as a passenger car. The vehicle control device 100 executes automatic driving of the host vehicle V. The automatic driving means that driving operations such as acceleration, deceleration, and steering of the host vehicle V are executed regardless of a driving operation of a driver of the host vehicle V. The vehicle control device 100 performs lane change control of the host vehicle V during the execution of the automatic driving. The lane change control means that the driving of the host vehicle V is controlled such that the host vehicle V performs a lane change from a driving lane on which the host vehicle V travels, to a neighboring lane which is contiguous to the driving lane. Further, the vehicle control device 100 displays a progress situation of the lane change to the driver of the host vehicle V through a display screen. Further, the vehicle control device 100 switches the automatic driving which is being executed to manual driving in a case where the amount of operation of a driving operation by the driver of the host vehicle V during the automatic driving is greater than or equal to a predetermined threshold value.

As shown in FIG. 1, the vehicle control device 100 is provided with an external sensor 1, a GPS (Global Positioning System) receiver 2, an internal sensor 3, a map database 4, a navigation system 5, an actuator 6, an HMI (Human Machine Interface) 7, auxiliary equipment U, and an ECU 10.

The external sensor 1 is detection equipment which detects an external situation that is information on the surroundings of the host vehicle V. The external sensor 1 includes a camera. Further, the external sensor 1 includes at least one of a radar and a LIDAR (Laser Imaging Detection and Ranging).

The camera is imaging equipment which images an external situation of the host vehicle V. The camera is provided on, for example, the back side of a front windshield of the host vehicle V. The camera may be a monocular camera or may be a stereo camera. A stereo camera has two imaging units disposed so as to reproduce, for example, a binocular parallax. Information in a depth direction is also included in the imaging information of the stereo camera. The camera outputs imaging information about the external situation of the host vehicle V to the ECU 10. Further, the camera may be not only a visible light camera, but also an infrared camera.

The radar detects an obstacle outside of the host vehicle V by using radio waves. The radio waves are, for example, millimeter waves. The radar transmits radio waves to the surroundings of the host vehicle V and receives the radio waves reflected by an obstacle, thereby detecting the obstacle. The radar can output, for example, a distance or a direction to the obstacle as obstacle information about the obstacle. The radar outputs the detected obstacle information to the ECU 10. In addition, in a case of performing sensor fusion, the radar may output receiving information of the reflected radio waves to the ECU 10.

The LIDER detects an obstacle outside of the host vehicle V by using light. The LIDER sends light to the surroundings of the host vehicle V and receives the light reflected by an obstacle, thereby measuring a distance to a reflection point and detecting the obstacle. The LIDER can output, for example, a distance or a direction to the obstacle as obstacle information. The LIDER outputs the detected obstacle information to the ECU 10. In addition, in a case of performing sensor fusion, the LIDER may output receiving information of the reflected light to the ECU 10. In addition, the radar and the LIDER need not necessarily be provided overlappingly.

The GPS receiver 2 receives signals from three or more GPS satellites, thereby acquiring position information indicating the position of the host vehicle V. For example, a latitude and longitude are included in the position information. The GPS receiver 2 outputs information on the measured position of the host vehicle V to the ECU 10. In addition, instead of the GPS receiver 2, other means capable of identifying the latitude and longitude at which the host vehicle V is present may be used.

The internal sensor 3 is a detector which detects information corresponding to a traveling state of the host vehicle V, and the amount of operation of any one of a steering operation, an accelerator operation, and a brake operation by the driver of the host vehicle V. The internal sensor 3 includes at least one of a vehicle speed sensor, an acceleration sensor, a yaw rate sensor, a yaw angle sensor, and a steering angle sensor in order to detect the information corresponding to the traveling state of the host vehicle V. Further, the internal sensor 3 includes at least one of a steering sensor, an accelerator pedal sensor, and a brake pedal sensor in order to detect the amount of operation.

The vehicle speed sensor is a detector which detects the speed of the host vehicle V. As the vehicle speed sensor, for example, a wheel speed sensor which is provided at a wheel of the host vehicle V or a drive shaft or the like which rotates integrally with the wheels, and detects the rotational speed of the wheels, may be used. The vehicle speed sensor outputs vehicle speed information (wheel speed information) which includes the speed of the host vehicle V to the ECU 10.

The acceleration sensor is a detector which detects the acceleration of the host vehicle V. The acceleration sensor includes, for example, a forward and backward acceleration sensor which detects the acceleration in a front-back direction of the host vehicle V, and a lateral acceleration sensor which detects the lateral acceleration of the host vehicle V. The acceleration sensor outputs acceleration information which includes the acceleration of the host vehicle V to the ECU 10.

The yaw rate sensor is a detector which detects a yaw rate (rotational angular velocity) around a vertical axis of the center of gravity of the host vehicle V. As the yaw rate sensor, for example, a gyro sensor is used. The yaw rate sensor outputs yaw rate information which includes the yaw rate of the host vehicle V to the ECU 10. The yaw angle sensor is a detector which detects the yaw angle of the host vehicle V. As the yaw angle sensor, for example, a gyro-type sensor can be used. The yaw angle sensor outputs a signal corresponding to the yaw angle of the host vehicle V to the ECU 10. The steering angle sensor is a detector which detects a direction of the front wheels of the host vehicle V. The steering angle sensor is installed at a steering mechanism for the front wheels. The steering angle sensor outputs a signal corresponding to the steering angle of the host vehicle V to the ECU 10.

The steering sensor is a detector which detects, for example, the amount of operation in an operation of steering a steering wheel by the driver of the host vehicle V. The amount of operation which is detected by the steering sensor is, for example, a steering angle of the steering wheel, or a steering torque given to the steering wheel. The steering sensor is provided at, for example, a steering shaft of the host vehicle V. The steering sensor outputs information which includes the steering angle of the steering wheel or the steering torque to the steering wheel to the ECU 10.

The accelerator pedal sensor is a detector which detects, for example, the amount of depression of an accelerator pedal. The amount of depression of the accelerator pedal is, for example, the position of the accelerator pedal (a pedal position) on the basis of a predetermined position. The predetermined position may be a fixed position or may be a position changed by a predetermined parameter. The accelerator pedal sensor is provided at, for example, a shaft section of the accelerator pedal of the host vehicle V. The accelerator pedal sensor outputs operation information corresponding to the amount of depression of the accelerator pedal to the ECU 10.

The brake pedal sensor is a detector which detects, for example, the amount of depression of a brake pedal. The amount of depression of the brake pedal is, for example, the position of the brake pedal (a pedal position) on the basis of a predetermined position. The predetermined position may be a fixed position or may be a position changed by a predetermined parameter. The brake pedal sensor is provided at, for example, a portion of the brake pedal. The brake pedal sensor may detect a force operating on the brake pedal (a depression force on the brake pedal, a pressure in a master cylinder, or the like). The brake pedal sensor outputs operation information corresponding to the amount of depression or the force operating on the brake pedal to the ECU 10.

The map database 4 is a database provided with map information. The map database 4 is formed in, for example, a HDD (Hard disk drive) mounted on the host vehicle V. For example, position information of a road, information about a road shape, and position information of an intersection and a branch point are included in the map information. For example, the types of a curve and a straight portion, the curvature of a curve, and the like are included in the information about a road shape. Further, in a case where the vehicle control device 100 uses position information of a shielding structure such as a building or a wall, or a SLAM (Simultaneous Localization and Mapping) technique, an output signal of the external sensor 1 may be included in the map information. In addition, the map database 4 may be stored in a computer of a facility such as an information processing center capable of communicating with the host vehicle V.

The navigation system 5 is a device which performs guidance to a destination set on a map by the driver of the host vehicle V for the driver of the host vehicle V. The navigation system 5 calculates a route on which the host vehicle V travels, based on the position information of the host vehicle V measured by the GPS receiver 2 and the map information of the map database 4. The route may be, for example, a route in which a driving lane on which the host vehicle V travels is specified in sections of a plurality of lanes. The navigation system 5 calculates, for example, a target route from the position of the host vehicle V to a destination and performs the notification of the target route to a driver by display of a display and an audio output of a speaker. The navigation system 5 outputs, for example, information about the target route of the host vehicle V to the ECU 10. In addition, the navigation system 5 may use the information stored in a computer of a facility such as an information processing center capable of communicating with the host vehicle V. Alternatively, some of processing which is performed by the navigation system 5 may be performed by the computer of the facility.

The actuator 6 is a device which executes the driving control of the host vehicle V. The actuator 6 includes a throttle actuator, a brake actuator, and a steering actuator. The throttle actuator controls the amount of air supplied to an engine (the degree of throttle opening) according to a control signal from the ECU 10, thereby controlling the drive force of the host vehicle V. In addition, in a case where the host vehicle V is a hybrid car or an electric automobile, the throttle actuator is not included, and a control signal from the ECU 10 is input to a motor as a power source, whereby the drive force is controlled.

The brake actuator controls a brake system according to a control signal from the ECU 10, thereby controlling a braking force which is applied to the wheels of the host vehicle V. As the brake system, for example, a hydraulic brake system can be used. The steering actuator controls the driving of an assist motor which controls a steering torque of an electric power steering system, according to a control signal from the ECU 10. In this way, the steering actuator controls the steering torque of the host vehicle V.

The HMI 7 is an interface for performing the output and the input of information between an occupant (including a driver) of the host vehicle V and the vehicle control device 100. The HMI 7 is provided with, for example, a display panel for displaying image information to the occupant, a speaker for an audio output, operation buttons or a touch panel for allowing the occupant to perform an input operation, and the like. The HMI 7 is provided with a display screen such as a display panel for displaying a progress situation of a lane change to the driver of the host vehicle. The display screen is displayed on, for example, a HUD (head-up display), a liquid crystal display of an installation panel, or the like. The HMI 7 may perform the output of information to the occupant by using a portable information terminal wirelessly connected thereto and may accept operation input by the occupant by using the portable information terminal.

The auxiliary equipment U is equipment which normally can be operated by the driver of the host vehicle V. The auxiliary equipment U is a general term for equipment which is not included in the actuator 6. The auxiliary equipment U here includes, for example, headlights, a wiper, and the like.

The ECU 10 performs the automatic driving of the host vehicle V. The ECU 10 is an electronic control unit having a CPU (Central Processing Unit), a ROM (Read Only Memory), a RAM (Random Access Memory), and the like. The ECU 10 has an environment recognition unit 11, a traveling plan generation unit 12, a control unit 13, and a display unit 14. In the ECU 10, the control of each unit such as the environment recognition unit 11 described above is executed by loading a program stored in the ROM into the RAM and executing the program in the CPU. The ECU 10 may be composed of a plurality of electronic control units.

The environment recognition unit 11 recognizes an environment around the host vehicle V, based on the information acquired by the external sensor 1, the GPS receiver 2, and the map database 4. The environment recognition unit 11 acquires information about, for example, lane lines (a white line and a yellow line), curbstones, a guiderail, a pole, and a center divider of a road, a stationary object such as a building or a tree, or a moving object such as a pedestrian, another vehicle, a motorcycle, or a bicycle, based on the information acquired by the external sensor 1. The environment recognition unit 11 acquires information about the distance between the host vehicle V and each lane line in a width direction of a road, or the distance between the host vehicle V and a central portion of each lane in the width direction of the road. Further, the environment recognition unit 11 acquires information about the distance between an obstacle and the host vehicle V, the position of the obstacle, and the relative speed of the obstacle with respect to the host vehicle V. Further, the environment recognition unit 11 acquires information about the shape, the curvature, the gradient, the number of lanes, the presence or absence of a branch, the presence or absence of traffic merging, and the like of the road on which the host vehicle V is traveling, based on the information acquired by the GPS receiver 2 and the map database 4.

The traveling plan generation unit 12 generates a traveling plan of the host vehicle V, based on the target route calculated in the navigation system 5, the information about an obstacle around the host vehicle V recognized by the environment recognition unit 11, and the map information acquired from the map database 4. The traveling plan is a locus in which the host vehicle V advances on the target route. For example, the speed, the acceleration, the deceleration, the direction, the steering angle, and the like of the host vehicle V at all times are included in the traveling plan. The traveling plan generation unit 12 generates a traveling plan in which the host vehicle V performs traveling which satisfies standards such as safety, legal compliance, and traveling efficiency, on the target route.

The control unit 13 automatically controls the driving of the host vehicle V, based on the traveling plan generated in the traveling plan generation unit 12. The control unit 13 outputs a control signal corresponding to the traveling plan to the actuator 6. In this way, the control unit 13 controls the driving of the host vehicle V such that the automatic driving of the host vehicle V is executed according to the traveling plan. The control unit 13 controls the driving of the host vehicle V such that the host vehicle V performs a lane change from the driving lane on which the host vehicle V travels to a neighboring lane which is contiguous to the driving lane, based on the traveling plan generated in the traveling plan generation unit 12, or a situation of another vehicle or the like around the host vehicle V recognized in the environment recognition unit 11. Further, the control unit 13 controls the driving of the host vehicle V such that the host vehicle V returns back to the driving lane, in a case where after the host vehicle V starts a movement to the neighboring lane, it is difficult to perform a lane change due to another vehicle or the like. Further, the control unit 13 switches the automatic driving which is being executed to manual driving, in a case where the amount of operation by the driver of the host vehicle V acquired by the internal sensor 3 is greater than or equal to a predetermined threshold value.

The display unit 14 displays the progress situation of the lane change to the driver of the host vehicle V through the display screen of the HMI 7. As will be described later, the display unit 14 displays a lane line which partitions the driving lane and the neighboring lane on the display screen in a perspective from the host vehicle V to the front of the host vehicle V. Further, the display unit 14 displays the lane line while changing a position of the lane line according to the progress situation of the lane change. The progress situation of the lane change means, for example, a change in relative positional relationship between the host vehicle V and the lane line at the time of the lane change. Further, the progress situation of the lane change means, for example, a change in relative positional relationship between the host vehicle V and a central portion of the driving lane or the neighboring lane at the time of the lane change. Alternatively, the progress situation of the lane change means, for example, an elapsed time from the start of the lane change.

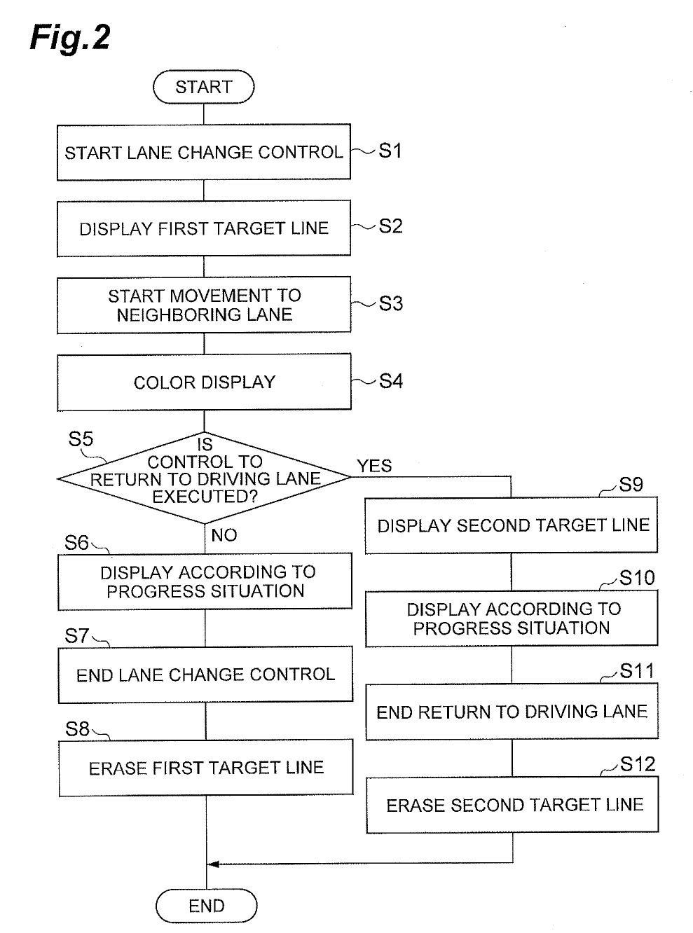

Next, processing which is executed in the vehicle control device 100 will be described. As shown in FIG. 2, the control unit 13 of the ECU 10 starts lane change control of the host vehicle V such that the host vehicle V performs a lane change from the driving lane on which the host vehicle V travels to the neighboring lane which is contiguous to the driving lane, based on the traveling plan generated in the traveling plan generation unit 12, and the situation of another vehicle or the like around the host vehicle V recognized in the environment recognition unit 11 (S1).

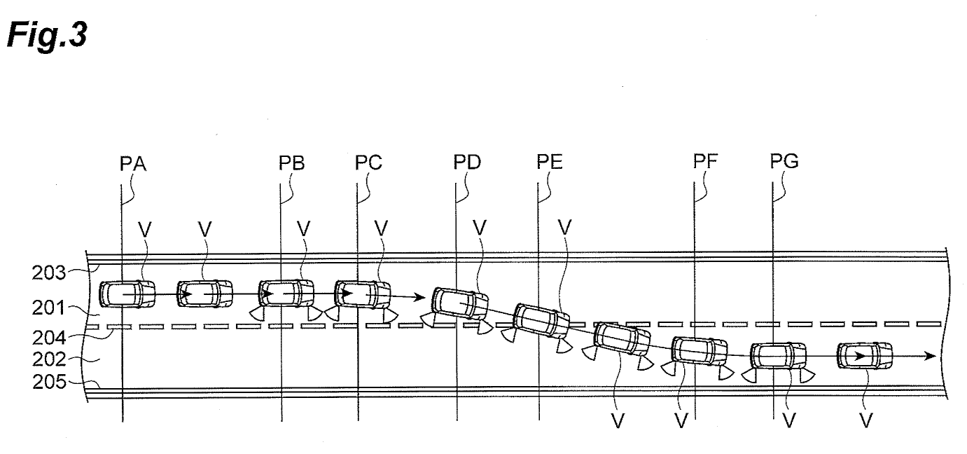

In the following description, as shown in FIG. 3, a situation in which a lane change is performed from a driving lane 201 on which the host vehicle V travels to a neighboring lane 202 which is contiguous to the driving lane 201 is assumed. The driving lane 201 and the neighboring lane 202 are defined by lane lines 203, 204, and 205. The road edge side of the driving lane 201 is defined by the lane line 203. The driving lane 201 and the neighboring lane 202 are partitioned by the lane line 204. The road edge side of the neighboring lane 202 is defined by the lane line 205. When the lane change control is started, the host vehicle V is being driven at a position PA.

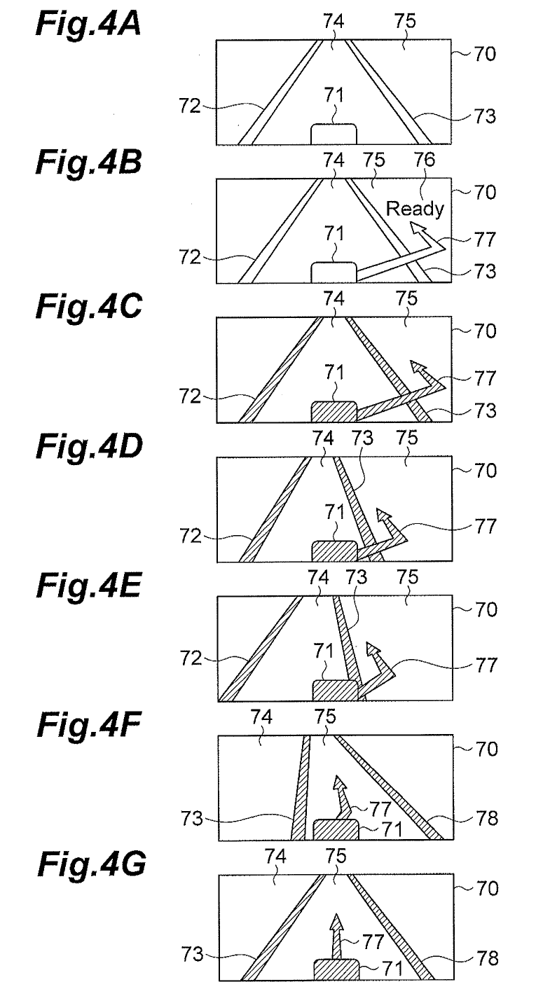

As shown in FIG. 4A, at the position PA, the display unit 14 of the ECU 10 displays a host vehicle front portion 71 which represents a front portion of the host vehicle V, a lane line 72 which represents the lane line 203, a lane line 73 which represents the lane line 204, a driving lane 74 which represents the driving lane 201, and a neighboring lane 75 which represents the neighboring lane 202, in a display screen 70 of the HMI 7 in a perspective from the host vehicle V to the front of the host vehicle V. The display unit 14 displays the host vehicle front portion 71 at a central portion of the display screen 70 and substantially symmetrically displays the lane lines 72 and 73 on both left and right sides of the display screen 70. At the position PA where the host vehicle V does not start a movement to the neighboring lane 202, the display unit 14 displays the host vehicle front portion 71 and the lane lines 72 and 73 without having a color.

As shown in FIG. 3, the host vehicle V reaches a position PB. The control unit 13 turns on the direction indicator lamp on the neighboring lane 202 side of the host vehicle V. As shown in FIGS. 2 and 4B, the display unit 14 displays a first target line 77 indicating a direction of a lane change in the display screen 70 (S2). The first target line 77 extends toward the neighboring lane 75 from the host vehicle front portion 71 of the central portion of the display screen 70 while crossing the lane line 73 in the direction of the lane change. The first target line 77 bends toward a direction parallel to a traveling direction of the neighboring lane 75 in the neighboring lane 75. The tip of the first target line 77 is made to be an arrow indicating the traveling direction of the neighboring lane 75. The display unit 14 displays ready display 76 indicating preparation for lane change, in the display screen 70. At the position PB where the host vehicle V does not start a movement to the neighboring lane 202, the display unit 14 displays the host vehicle front portion 71, the lane lines 72 and 73, the ready display 76, and the first target line 77 without having a color.

As shown in FIG. 3, the host vehicle V reaches a position PC. As shown in FIG. 2, the control unit 13 causes the host vehicle V to start a movement to the neighboring lane 202 (S3). As shown in FIGS. 2 and 4C, at the position PC after the host vehicle V starts the movement to the neighboring lane 202, the display unit 14 displays the host vehicle front portion 71, the lane lines 72 and 73, and the first target line 77 having a color (S4). The display unit 14 displays the host vehicle front portion 71, the lane lines 72 and 73, and the first target line 77 having a color of, for example, blue, red, yellow, green, or purple.

As shown in FIG. 2, in a case where after the host vehicle V starts the movement to the neighboring lane 202, the driving of the host vehicle V is not controlled by the control unit 13 such that the host vehicle V returns back to the driving lane 201 (S5), the display unit 14 displays the lane lines 72 and 73 while changing the positions of the lane lines 72 and 73 in the display screen 70 according to the progress situation of the lane change (S6).

As shown in FIG. 3, the host vehicle V having started the movement to the neighboring lane 202 reaches a position PD. The host vehicle V approaches the lane line 204. As shown in FIG. 4D, the display unit 14 displays the lane line 73 in close proximity to the host vehicle front portion 71 of the central portion of the display screen 70 in correspondence to the distance between the host vehicle V and each of the lane lines 203, 204, and 205 in the width direction of the road recognized by the environment recognition unit 11, or the distance between the host vehicle V and each of central portions of the driving lane 201 and the neighboring lane 202 in the width direction of the road, and displays the lane line 72 to be distanced from the host vehicle front portion 71. The length of the first target line 77 extending from the host vehicle front portion 71 until it bends becomes shorter as the host vehicle V approaches the lane line 204.

As shown in FIG. 3, the host vehicle V reaches a position PE where it straddles the lane line 204. As shown in FIG. 4E, the display unit 14 performs display such that the host vehicle front portion 71 of the central portion of the display screen 70 straddles the lane line 73 in correspondence to the positional relationship between the host vehicle V and the lane lines 203 and 204, and displays the lane line 72 to be further distanced from the host vehicle front portion 71. The host vehicle V straddles the lane line 204, and therefore, the length of the first target line 77 extending from the host vehicle front portion 71 until it bends becomes even shorter.

As shown in FIG. 3, the host vehicle V reaches a position PF where it has passed across the lane line 204. As shown in FIG. 4F, the display unit 14 displays the lane line 73 and a lane line 78 which represents the lane line 205, in the display screen 70, in correspondence to the positional relationship between the host vehicle V and the lane lines 204 and 205. The first target line 77 extends from the host vehicle front portion 71 to a central portion of the neighboring lane 75 and then bends toward a traveling direction of the neighboring lane 75 from the central portion of the neighboring lane 75.

As shown in FIG. 3, the host vehicle V reaches a position PG where it travels on the central portion of the neighboring lane 202. As shown in FIG. 4c the display unit 14 displays the host vehicle front portion 71 of the central portion of the display screen 70 in the display screen 70 in correspondence to the positional relationship between the host vehicle V and the lane lines 204 and 205 and substantially symmetrically displays the lane lines 73 and 78 on both left and light sides of the display screen 70. The first target line 77 extends from the host vehicle front portion 71 to the central portion of the neighboring lane 75 without bending.

As shown in FIG. 2, if the control unit 13 ends the lane change control (S7), the display unit 14 erases the first target line 77 from the display screen 70 (S8). The display unit 14 displays the host vehicle front portion 71 and the lane lines 73 and 78 without having a color, in the display screen 70.

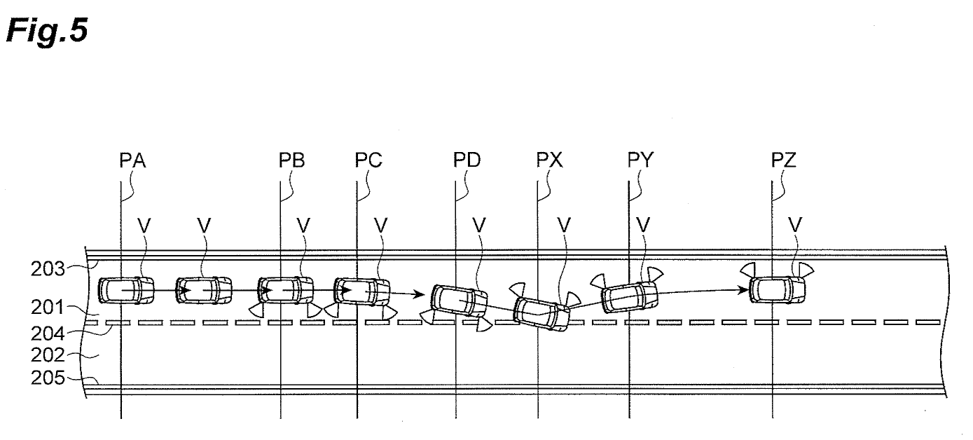

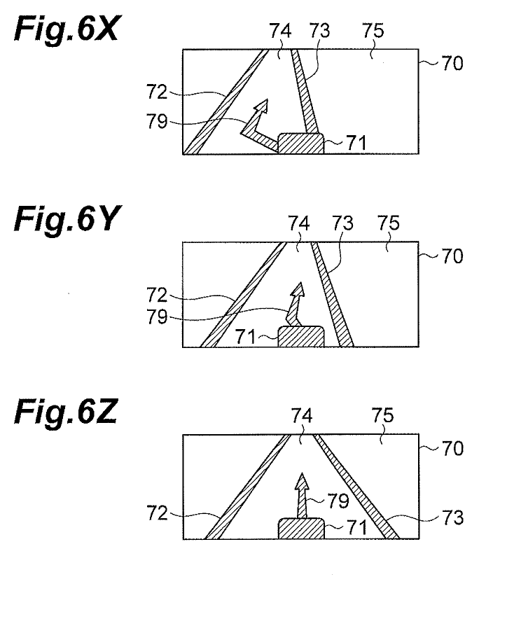

On the other hand, as shown in FIG. 2, a case where after the host vehicle V starts the movement to the neighboring lane 202, a lane change becomes difficult due to the existence or the like of another vehicle, and thus the driving of the host vehicle V is controlled by the control unit 13 such that the host vehicle V returns back to the driving lane 201, will be described (S5). As shown in FIG. 5, at a position PX, the control unit 13 controls the host vehicle V such that the host vehicle V returns back to the driving lane 201, while turning on the direction indicator lamp on the driving lane 201 side of the host vehicle V. As shown in FIGS. 2 and 6X, the display unit 14 displays a second target line 79 indicating a return to the driving lane 74, in the display screen 70 (S9).

The second target line 79 extends from the host vehicle front portion 71 of the central portion of the display screen 70 to a central portion of the driving lane 74 and then bends toward a traveling direction of the driving lane 74 from the central portion of the driving lane 74. The tip of the second target line 79 is made to be an arrow indicating the traveling direction of the driving lane 74. The display unit 14 displays the second target line 79 having a color, similar to the host vehicle front portion 71 and the lane lines 72 and 73.

As shown in FIG. 5, the host vehicle V reaches a position PY where it has returned back to the central portion of the driving lane 201. As shown in FIGS. 2 and 6Y, the display unit 14 displays the lane lines 72 and 73 while changing the positions of the lane lines 72 and 73 in the display screen 70 according to the progress situation of the return to the driving lane 201 (S10). The length of the second target line 79 extending from the host vehicle front portion 71 until it bends becomes shorter as the host vehicle V approaches the central portion of the driving lane 201.

As shown in FIG. 5, the host vehicle V returns back to a position PZ where it travels on the central portion of the driving lane 201. As shown in FIG. 6Z, the display unit 14 displays the host vehicle front portion 71 of the central portion of the display screen 70 in the display screen 70 in correspondence to the positional relationship between the host vehicle V and the lane lines 203 and 204 and substantially symmetrically displays the lane lines 72 and 73 on both left and light sides of the display screen 70. The second target line 79 extends from the host vehicle front portion 71 to the central portion of the driving lane 74 without bending.

If the control unit 13 ends the control to return the host vehicle V to the driving lane 201 (S11), the display unit 14 erases the second target line 79 from the display screen 70 (S12). The display unit 14 displays the host vehicle front portion 71 and the lane lines 72 and 73 without having a color, in the display screen 70, as shown in FIG. 4A.

According to this embodiment, by the display unit 14 of the vehicle control device 100, the lane line 73 which partitions the driving lane 74 and the neighboring lane 75 is displayed on the display screen 70 in a perspective from the host vehicle V to the front of the host vehicle V and the lane line 73 is displayed while the position of the lane line 73 is changed according to the progress situation of the lane change. For this reason, the movement of the lane line 73 in display of the display screen 70 and the movement of the lane line 204 at the point of view of the driver of the host vehicle V become more similar. Therefore, the driver of the host vehicle V has a reduced uncomfortable feeling with the display of the display screen 70, and thus it becomes easier for the driver of the host vehicle V to grasp the progress situation of the lane change.

Further, the first target line 77 indicating the direction of the lane change is displayed in the display screen 70 on which similar display to that at the point of view of the driver is performed, by the display unit 14, and the shape of the first target line 77 is changed according to the progress situation of the lane change. Therefore, it becomes easier for the driver of the host vehicle V to grasp the direction of the lane change or the progress situation of the lane change.

Further, by the display unit 14, display without having a color is performed before the host vehicle V starts the movement to the neighboring lane 202 and display having a color is performed after the host vehicle V starts the movement to the neighboring lane 202. Therefore, it becomes easier for the driver of the host vehicle V to grasp whether or not the movement to the neighboring lane 202 has started.

Further, in a case where after the host vehicle V starts the movement to the neighboring lane 202, the driving of the host vehicle V is controlled such that the host vehicle V returns back to the driving lane 201, the second target line 79 indicating the return to the driving lane 201 is displayed in the display screen 70 by the display unit 14. Therefore, it becomes easier for the driver of the host vehicle V to grasp the driving of the host vehicle V being controlled such that the host vehicle V returns back to the driving lane 201,

An embodiment of the present invention has been described above. However, the present invention can be implemented in various forms without being limited to the above-described embodiment. For example, the display unit 14 may not display the host vehicle front portion 71 in the display screen 70. Further, the display unit 14 may not display either or both of the first target line 77 and the second target line 79. Further, the display unit 14 may necessarily display only one of display without having a color and display having a color.

Further, the display unit 14 may not necessarily perform display while changing the positions of the lane lines 72, 73, and 78 in the display screen 70 in correspondence to the distance between the host vehicle V and each of the lane lines 203, 204, and 205 in the width direction of the road accurately recognized, or the distance between the host vehicle V and each of the central portions of the driving lane 201 and the neighboring lane 202 in the width direction of the road accurately recognized. For example, the display unit 14 may perform display while changing the positions of the lane lines 72, 73, and 78 in the display screen 70, based on information about an approximate position of the host vehicle V acquired by the GPS receiver 2. Further, for example, the display unit 14 may perform display while changing the positions of the lane lines 72, 73, and 78 in the display screen 70, based on an elapsed time from the start of the lane change.

Further, the display unit 14 may not necessarily perform display while smoothly and continuously changing the positions of the lane lines 72, 73, and 78 or the shapes of the first target line 77 and the second target line 79 in the display screen 70. The display unit 14 may perform display while changing the positions of the lane lines 72, 73, and 78 or the shapes of the first target line 77 and the second target line 79 in the display screen 70 in stages at discrete times, for example.

Further, the display unit 14 may perform display while changing the positions of the lane lines 72, 73, and 78 or the shapes of the first target line 77 and the second target line 79 in the display screen 70 according to the yaw rate, the yaw angle, the steering angle, and the like of the host vehicle V detected by the internal sensor 3. In this case, for example, the larger the yaw rate, the yaw angle, the steering angle, and the like of the host vehicle V, the further the display unit 14 can increase a speed at which the positions of the lane lines 72, 73, and 78 or the shapes of the first target line 77 and the second target line 79 in the display screen 70 change. Further, for example, the larger the yaw rate, the yaw angle, the steering angle, and the like of the host vehicle V, the further the display unit 14 can increase angles with respect to the driving lane 74 and the neighboring lane 75, of the first target line 77 and the second target line 79 in the display screen 70.

Further, the display unit 14 may display the first target line 77 and the second target line 79 having colors different from each other. Alternatively, in a case where after the host vehicle V starts the movement to the neighboring lane 202, the driving of the host vehicle V is controlled by the control unit 13 such that the host vehicle V returns back to the driving lane 201, the display unit 14 may display a letter or the like indicating that the host vehicle V returns back to the driving lane 201, in the display screen 70, in addition to the second target line 79.

Further, the vehicle control device 100 may not necessarily execute the automatic driving of the host vehicle V. The vehicle control device 100 may display the progress of the lane change to the driver of the host vehicle V through the display screen 70, as in the above-described embodiment, while executing control for the lane change of the host vehicle V to a neighboring lane, regardless of a driving operation of the driver of the host vehicle V, in all or some of operations from the start to the completion of the lane change of the host vehicle V, according to, for example, an instruction to change a lane to a neighboring lane from the driver of the host vehicle V. The instruction to change a lane means, for example, an instruction given by a driver to perform lane change control to the neighboring lane 202 on the vehicle control device 100, by an input operation or the like to the direction indicator lamp or the like by the driver of the host vehicle V. The lane change instruction may be performed by voice input of the driver, detection of an operation of turning a face to the neighboring lane 202, and line-of-sight detection (for example, detection of a gaze at a side mirror reflecting the neighboring lane 202).

What is claimed is:

1. A vehicle control device which controls driving of a host vehicle such that the host vehicle performs a lane change from a driving lane on which the host vehicle travels to a neighboring lane which is contiguous to the driving lane, and displays a progress situation of the lane change to a driver of the host vehicle through a display screen, comprising:
a display unit configured to display a lane line which partitions the driving lane and the neighboring lane, on the display screen in a perspective from the host vehicle to the front of the host vehicle,
wherein the display unit is configured to display the lane line while changing a position of the lane line according to the progress situation of the lane change.

2. The vehicle control device according to claim 1, wherein the display unit is configured to display a first target line indicating a direction of the lane change, in the display screen, and display the first target line while changing a shape of the first target line according to the progress situation of the lane change.

3. The vehicle control device according to claim 1, wherein the display unit is configured to perform display without having a color, before the host vehicle starts a movement to the neighboring lane, and perform display having a color, after the host vehicle starts a movement to the neighboring lane.

4. The vehicle control device according to claim 2, wherein the display unit is configured to perform display without having a color, before the host vehicle starts a movement to the neighboring lane, and perform display having a color, after the host vehicle starts a movement to the neighboring lane.

5. The vehicle control device according to claim 1, wherein in a case where after the host vehicle starts a movement to the neighboring lane, the driving of the host vehicle is controlled such that the host vehicle returns back to the driving lane,
the display unit is configured to display a second target line indicating a return to the driving lane, in the display screen.

6. The vehicle control device according to claim 2, wherein in a case where after the host vehicle starts a movement to the neighboring lane, the driving of the host vehicle is controlled such that the host vehicle returns back to the driving lane,
the display unit is configured to display a second target line indicating a return to the driving lane, in the display screen.

7. The vehicle control device according to claim 3, wherein in a case where after the host vehicle starts a movement to the neighboring lane, the driving of the host vehicle is controlled such that the host vehicle returns back to the driving lane,
the display unit is configured to display a second target line indicating a return to the driving lane, in the display screen.

8. The vehicle control device according to claim 4, wherein in a case where after the host vehicle starts a movement to the neighboring lane, the driving of the host vehicle is controlled such that the host vehicle returns back to the driving lane,
the display unit is configured to display a second target line indicating a return to the driving lane, in the display screen.
